(19) United States
(12) Patent Application Publication
(10) Pub. No.: US 2018/0001705 A1
(43) Pub. Date: Jan. 4, 2018

(54) MOLDED ARTICLE AND IMPROVED VENTING ASSEMBLY FOR A ROTATING MOLD

(71) Applicant: Compagnie Generale des Etablissements Michelin, Clermont-Ferrand (FR)

(72) Inventor: Brian Douglas WILSON, Greer, SC (US)

(21) Appl. No.: 15/541,272

(22) PCT Filed: Dec. 29, 2015
(86) PCT No.: PCT/US15/67893

§ 371 Date: Jun. 30, 2017

Related U.S. Application Data
(60) Provisional application No. 62/098,429, filed on Dec. 31, 2014.

(51) Int. Cl. B60C 7/18; B60B 9/04; B29C 41/04; B60B 9/26; B29D 30/02; B60C 7/14

(52) U.S. Cl. CPC B60C 7/18; B60B 9/26; B29D 30/02; B60B 9/04; B29C 41/042; B60B 2900/321; B60B 2900/572; B60C 2007/146

(57) ABSTRACT

A molded article with an axis of rotation about a central axis having an outer interface element, an inner interface element, and a plurality of web spokes positioned therebetween. The common surfaces of the inner and outer interface elements and a pair of adjacent web spokes form a void space. The radially inner surface of an interface element common to one of the voids has a maximum radius of curvature in the longitudinal direction at any given point less than the distance between that point and the axis of rotation.

### BACKGROUND

Non-pneumatic deformable structures for use in the support of loads under rolling conditions, such as to support loads for automotive vehicles have been described, for example in U.S. Pat. No. 7,201,194, which is commonly owned by the assignee of the current invention and is incorporated by reference in its entirety. The structurally supported, non-pneumatic tire disclosed therein includes an annular band that supports the load, a plurality of web spokes that transmit in tension the load forces between the annular band and a wheel or hub. A particularly useful design for the web spokes that improves spoke durability and allows the designer to vary the initial stiffness of vertical load versus vertical deflection is disclosed in United States Patent Publication No. 2009/0294000A1, which is also commonly owned by the assignee of the current invention and is incorporated by reference in its entirety. The non-pneumatic article supports its load solely through the structural properties and, contrary to the mechanism in pneumatic tires, without support from internal air pressure. In further embodiments, the annular shear band may comprise one or more sets of reinforcements that are radially spaced apart by an elastomeric material to form a shear layer between sets of reinforcements. In a particular embodiment, the shear band comprises a first membrane adhered to the radially inward extent of the shear layer and at least a second membrane adhered to the radially outer extent of the shear layer.

The non-pneumatic deformable structure may be manufactured by several alternative means. In one exemplary method the shear layer and web spokes may be made of the same material, for example polyurethane, and can be manufactured by a molding process to produce the non-pneumatic article. An alternative means comprises manufacturing the annular shear band as a separate article, and then forming the complete article by molding the spokes in a mold that uses the annular band as the radially outer surface and the hub as the radially inner surface. This method allows the designer to specify different materials for the annular band and for the web spokes. For the exemplary article disclosed in U.S. Pat. No. 7,201,194, the annular band comprises a rubber shear layer and includes an outer tread portion that is constructed and then vulcanized as a unit by conventional means known in the tire industry. The annular band and the hub are placed in a mold, where the mold cores and profiles define the geometry of the spokes for the finished article.

A common molding technique used for articles having axisymmetric elements (the annular band and the hub) and essentially radial elements (the web spokes) is to use a centrifugal casting method where the mold rotates at a given rotation speed and the material to be molded is poured into the mold near the axis of rotation of the mold. In an exemplary method, a two-part polyurethane elastomer is premixed, and then poured into the mold, allowed to cure, and then the finished article may be removed from the mold. The centripetal force created by the rotation of the mold produces a radial pressure gradient component in the liquid elastomer that facilitates complete filling of the mold to avoid molding deficiencies in the finished article. For an example where the mold rotates about a vertical axis of rotation, the centripetal pressure gradient component combines with a gravitational pressure gradient component.

In such a process it is not unexpected for air to be entrapped either in the premixed polyurethane or in small cavities within the mold. In either case, the entrapped air can form small bubbles which negatively affect the aesthetic appearance or, possibly, the fatigue durability of the finished article. The small air bubbles have a density which is on the order of one thousand times less than the density of the polyurethane. Under the actions of the centripetal and gravitational pressure gradients, the bubbles are subject to a buoyancy force that tends to cause the bubbles to migrate to the axially upper edge of the interface between the spoke element and the annular band. The finished article will then contain small voids at this location which may negatively affect the fatigue durability of the finished article.

Accordingly, there is a need to solve the problem of voids in the finished non-pneumatic article and to improve the performance of the article. A new design of the molded article and the corresponding mold is thereby disclosed that urges the entrapped air bubbles to migrate towards a location where they can be vented, thereby eliminating the voids in the finished article.

### SUMMARY OF THE EXEMPLARY EMBODIMENTS

A molded article having an axis of rotation about a central axis comprises an outer interface element having a circumference and an axial width, an inner interface element having a circumference and an axial width, and a plurality of web spokes positioned therebetween. The web spokes are oriented in a generally radial direction. The common surfaces of the inner interface element, the outer interface element, and a pair of adjacent web spokes forms a void space bounded by the common surfaces. At least a portion of the interface element common to one of the void spaces has a radially inward facing, singlely curved surface between two adjacent web spokes with a curvature in the longitudinal direction with a maximum radius of the curvature in the longitudinal direction less than the distance between that point and the axis of rotation.

In an exemplary embodiment of the molded article, the radius of curvature in the longitudinal direction along the surface is defined by a set of increasing thicknesses of the outer interface band at circumferential locations between the midpoint between a pair of adjacent web spokes and at least one of the adjacent web spokes. In a yet another embodiment the curvature of the inner surface of the outer interface band is defined by one or more control radii. The one or more control radii may comprise a first control radius at a circumferential location corresponding to a mid point between a pair of adjacent web spokes, a second control radius at a circumferential location at the intersection of the interface element with a first web spoke, and a third control radius at a circumferential location at the intersection of the interface element with a second web spoke adjacent to the first web spoke.

In another embodiment adapted to a mold having upper and lower parts, the maximum longitudinal radius of curvature of the portion of the interface element corresponding to a first void space is less than the distance between that point and the central axis, and the longitudinal radius of curvature of a majority of the surface of the portion of the interface element corresponding to a second void space equal to the distance between the surface and the central axis. Furthermore, the first and second void spaces may be circumferentially adjacent.

### BRIEF DESCRIPTION OF THE DRAWINGS

FIG. 1 depicts a non-pneumatic deformable structure 100 in rolling contact with a flat surface having radially oriented spokes.

FIG. 2 depicts a non-pneumatic deformable structure 100 in rolling contact with a flat surface and having an optimized spoke shape.

FIG. 3 is a detail view looking axially downward of the non-pneumatic deformable structure 100 showing the shape of the molded spoke at its attachment to the annular band.

FIG. 4 is a detail view of a non-pneumatic deformable structure 100 looking in the circumferential direction showing the cross-section A-A as indicated in FIG. 3 and following the path of a spoke 122.

FIG. 5 is a schematic view of a rotating mold 10 for the manufacture of a non-pneumatic deformable structure.

FIG. 6 schematic representation of forces acting on an entrained air bubble

FIG. 7 is an isometric view a non-pneumatic deformable structure 100 showing the areas where air bubbles may become trapped.

FIG.8 is an isometric view a non-pneumatic deformable structure 200 showing an improved shape to reduce the tendency to trap air bubbles.

FIG.9 is an isometric view a non-pneumatic deformable structure 200 showing the reduced longitudinal radius of curvature along the radially inward facing surface of the annular band.

FIG. 10 is an isometric view an alternative embodiment of a non-pneumatic deformable structure 200 showing variable edge radius along the periphery of the annular band and a reduced longitudinal radius of curvature along the radially inward facing surface of the annular band.

FIG. 11 is a schematic view looking axially downward on an embodiment of the non-pneumatic deformable structure 200 showing the radii of curvature of the inner surface of the outer interface element.

FIG. 12 shows a schematic view looking axially downward on the non-pneumatic deformable structure 100 showing the radii of curvature of the inner surface of the outer interface element.

FIG. 13 shows a schematic view looking axially downward on an embodiment of the non-pneumatic deformable structure 200 showing a reduced radii of curvature of the inner surface of the outer interface element between a first void space and an adjacent second void space.

### DETAILED DESCRIPTION

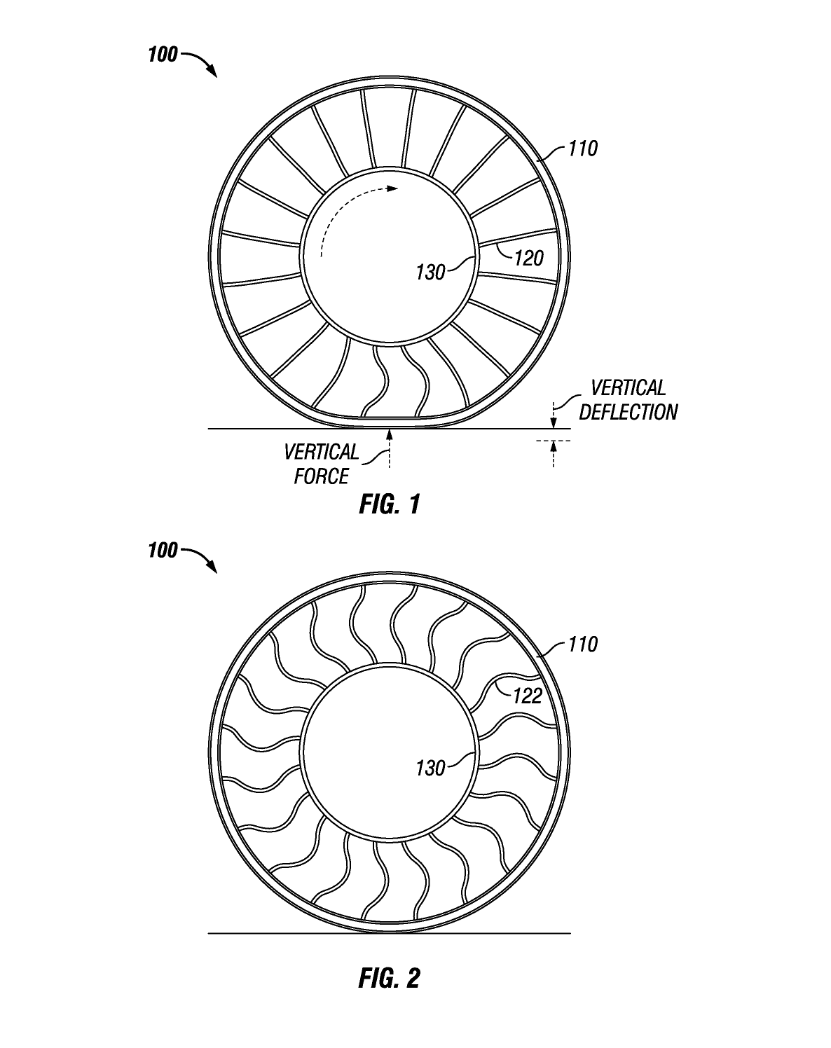

FIG. 1 depicts a non-pneumatic deformable structure 100 of the type disclosed in U.S. Pat. No. 7,201,194 in rolling contact under a vertical force F_{z} which produces a vertical deflection Δ. As shown in FIG. 1, FIG. 2, the non-pneumatic deformable structure 100 comprises an outer annular band 110, which may include a tire-like tread portion (not shown) for contacting the ground, and inner hub 130 for attaching the structure 100 to a rotating means such as a vehicle axle, and a plurality of web spokes 120 and 122 which connect the band 110 to the hub 130. In the embodiment shown, the spokes 120 or 122 are not directly molded against the band 110 and the hub 130. Instead, the radially inner ends of the spokes terminate in an inner interface element 124, and the radially outer ends of the spokes terminate in an outer interface element 126. That is to say, the inner cavity of mold 10 is designed so that the spokes 120 or 122 and the interface elements 124 and 126 are molded as a monolithic structure. For the exemplary embodiment shown in FIG. 4, the interface elements 124 and 126 form essentially annular rings that are molded as the spokes are molded to form a molded article. In the embodiment disclosed herein, the molded article is manufacture in situ by molding against the annular band 110 and the hub 130, thereby providing a secure attachment of the molded article to the outer annular band 110 and the hub 130. The spokes may be molded integrally with a torroidal shaped band such as disclosed in application PCT/US14/38472, herein incorporated by reference in its entirety.

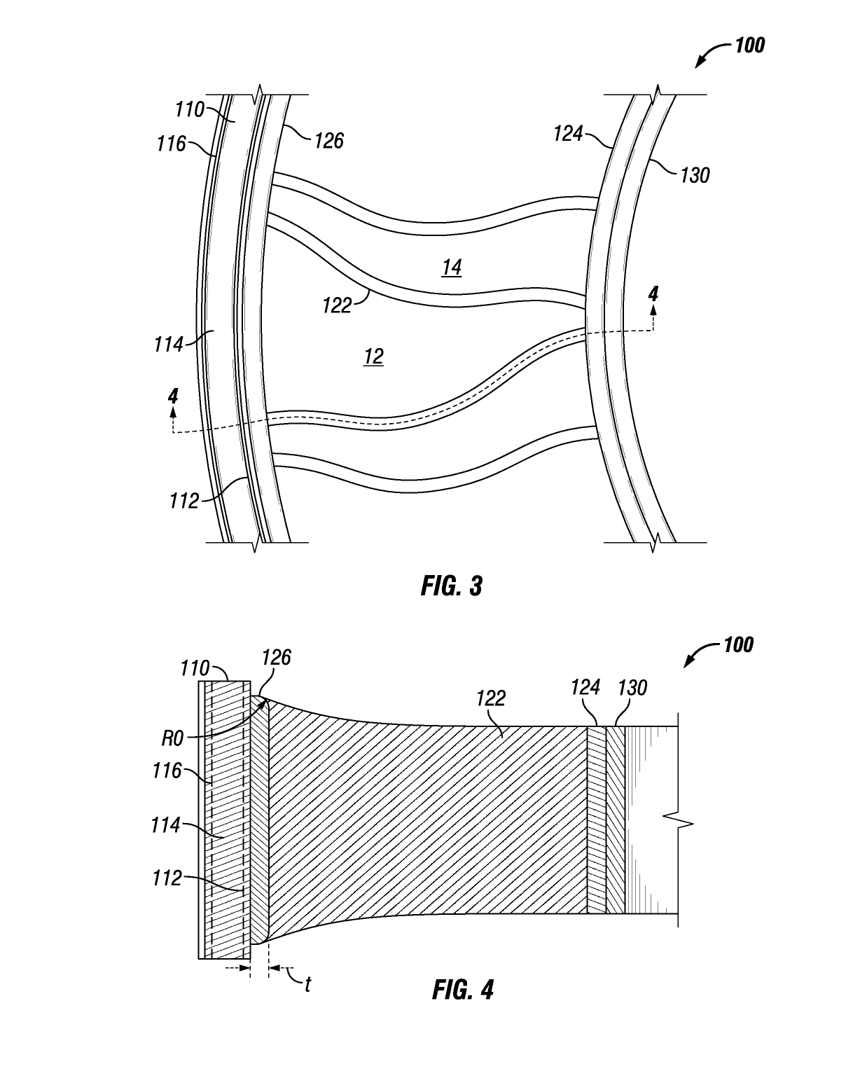

However it is equally possible to manufacture the molded article as a separate piece and thereafter attach this to the annular band 110 and the hub 130 by any suitable means. As non-limiting examples, the molded article could be attached by adhesive bonding, by mechanical fixation, by an interference fit between the band 110 and the hub 130. The band 110 may further comprise a reinforcement structure as shown in FIG. 3 and FIG. 4, which depict a first or inner membrane 112, a shear layer 114, and a second or outer membrane 116. The term membrane as used herein refers to an annular element having a significantly higher tensile modulus in the circumferential direction than shear modulus of the shear layer 114. Exemplary embodiments of the membranes 112 and 116 may contain a reinforced layer using textile or metallic cords or a homogeneous material having a modulus significantly higher than the shear layer 114. FIG. 4 depicts cord reinforcing elements oriented in the circumferential direction. A more detailed description of such a non-pneumatic deformable structure can be found in U.S. Pat. No. 7,201,194, which is incorporated by reference in its entirety.

The tensile and bending rigidity of the outer annular band 110 provide a load carrying path to the hub 130 by tensile forces in the spokes 120. As can be appreciated in FIG. 1, the spokes within the area in contact with the ground are designed to buckle when submitted to a compressive load. Thus, the structure 100 supports the applied load by tensile forces in the spokes which are outside the contact area. As the structure rolls, both the band 110 and the spokes 120 are subjected to large deformations of the type described in U.S. Pat. Publication No. 2009/0294000A1, which is incorporated by reference in its entirety. It will be readily appreciated by one skilled in the art that any molding anomaly, like that caused by a small air bubble, will produce a stress concentration that may impact fatigue durability.

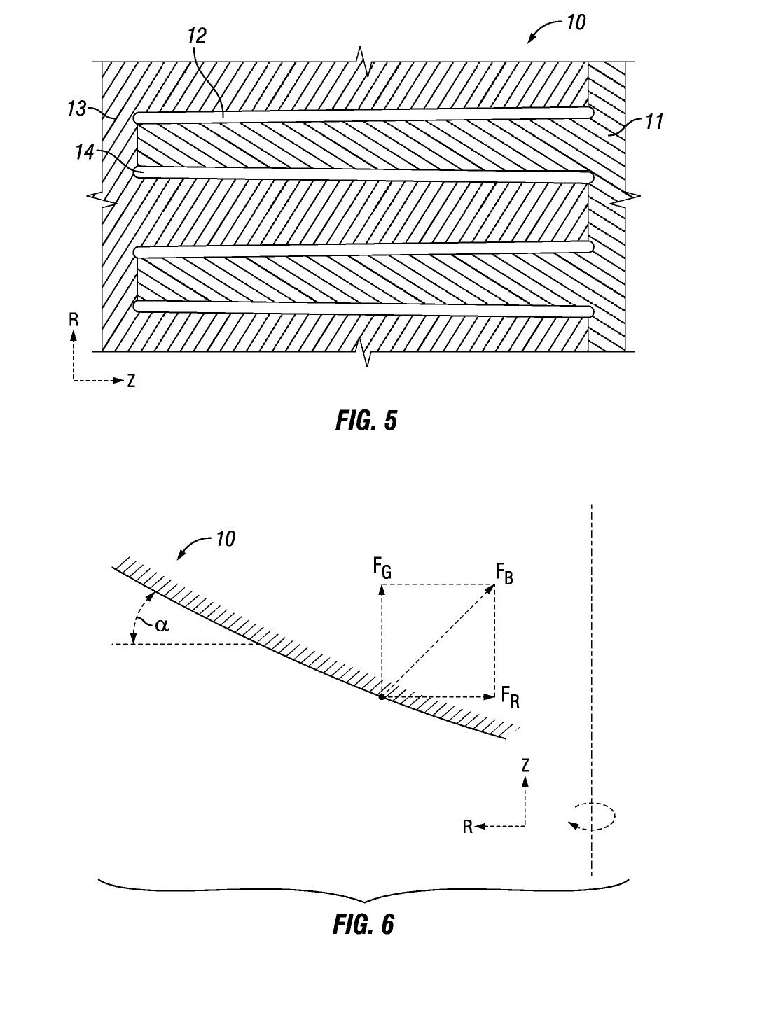

A better understanding of the problem of the location of the bubbles can be had by reference to FIG. 4 and FIG. 5. FIG. 5 depicts a schematic view of a rotating mold 10 used to manufacture the non-pneumatic deformable structure 100. The mold 10 comprises a an upper mold part (to the right side of FIG. 5) containing a first set of axially oriented cores or fingers 11 projecting downward from the top of the mold and terminating axially in contact with the lower mold part. During the manufacturing process, the mold rotates about an axis that is common to the axis of rotation for the molded article. The first set of cores forms a first set of voids 12 between pairs of spokes 120 or 122. The mold 10 has a lower part (to the left side of FIG. 5) containing a second set axially oriented cores or fingers 13 projecting upward from the bottom of the lower mold part and terminating axially in contact with the upper mold part. The second set of cores forms a second set of voids 14 between the remaining sets of spokes 120 or 122. In the example described herein, the cores alternate between the upper mold part and the lower mold part. The radially inner ends of the cores terminate at a radius greater than the outer radius of the hub 130 to provide a mold cavity for forming the inner interface element 124. Likewise, the radially outer ends of the cores terminate at a radius less than the inner radius of the annular band 110 to provide a mold cavity for forming the outer interface element 126.

During the manufacturing of the non-pneumatic deformable structure 100, the outer annular band 110 and the hub 130 are first positioned in the mold concentric with the mold axis to form the radially outer and inner mold surfaces. Next, the upper mold part and lower mold part close and form the casting cavity for the interface elements 124 and 126 and the spokes 120 or 122. The molding process uses a rotating mold 10 for what is known in the art as centrifugal casting. The casting material is a two-part polyurethane that is premixed and then poured into the mold from the top and near the axis of rotation. For the example described herein, the polyurethane is a commercially available product sold under the trade name Vibrathane® B836 manufactured by Chemtura Corporation.

Any air bubbles that may be entrained in the uncured polyurethane mix will be subjected to a buoyancy force which has a vertical component due to gravity and a radial component due to centripetal acceleration, the latter arising from the rotation of the mold. FIG. 6 depicts a schematic representation of a small air bubble (shown by the cross-hatching) in contact with an upper surface of the mold 10. In this example the mold surface has a slope defined by the angle α with respect to the horizontal. The buoyancy force FB on the bubble is a vector sum of the gravity component FG and the centripetal or rotational component FR. That is to say:

\vec{FB}=\vec{FG}+\vec{FR} \vec{FG}=ρgV \vec{FR}=ρω²RV
where,
ρ=density of the casting material
g=gravitational constant
ω=angular velocity of the mold rotation
V=volume of the bubble

For a non-rotating mold, or gravity casting, the rotational component FR is zero and the buoyancy force vector FB is vertically upward. An entrained bubble will move up the slope of the mold and tend to rise to the highest point in the mold. However, when the mold rotates, the rotational component FR is directed radially inward, and the resultant buoyancy vector FB is rotates inward as well. If the rotation of the mold increases sufficiently, the resultant vector FB will move to an angle that is normal to the mold surface. Under this condition, the bubble is in equilibrium and will tend to remain at its radial and vertical location. When the rotation of the mold is further increased, the resultant vector FB is directed inward of the normal to the mold, and the bubble will tend to be driven inward along the slope of the mold surface. This condition may be advantageous to urge the bubble to move to a location where there is sufficient mold venting to expel the bubble from the molding material.

Turning now to FIG. 4 and to FIG. 7. The outer interface element 126 appears in FIG. 4 in cross section view and is defined by a thickness t, an axial width w. The radially outer surface of the outer interface element 126 is cast against the radially inner surface of the annular band 110. The outer interface element 126 is formed from the section of the mold 10 where the cores project from the upper mold part towards the bottom of the mold. The cylindrical portion of the mold between the spokes does not possess a venting path. Therefore, during the molding operation and depending on the angular velocity of mold rotation ω, a bubble will tend towards an equilibrium position where the tangent to the portion of the mold forming the inner surface of the outer interface element is perpendicular to the resultant buoyancy vector FB. The equilibrium angle α is given by the equation:

$$α = {tan}^{- 1} ( FR / FG ) = {tan}^{- 1} ( \frac{{ω}^{2} R}{g} )$$

The equilibrium angle α is about 45 degrees for an exemplary geometry where the molded article has a maximum radius of 300 mm and the mold is rotating at about 55 rpm.

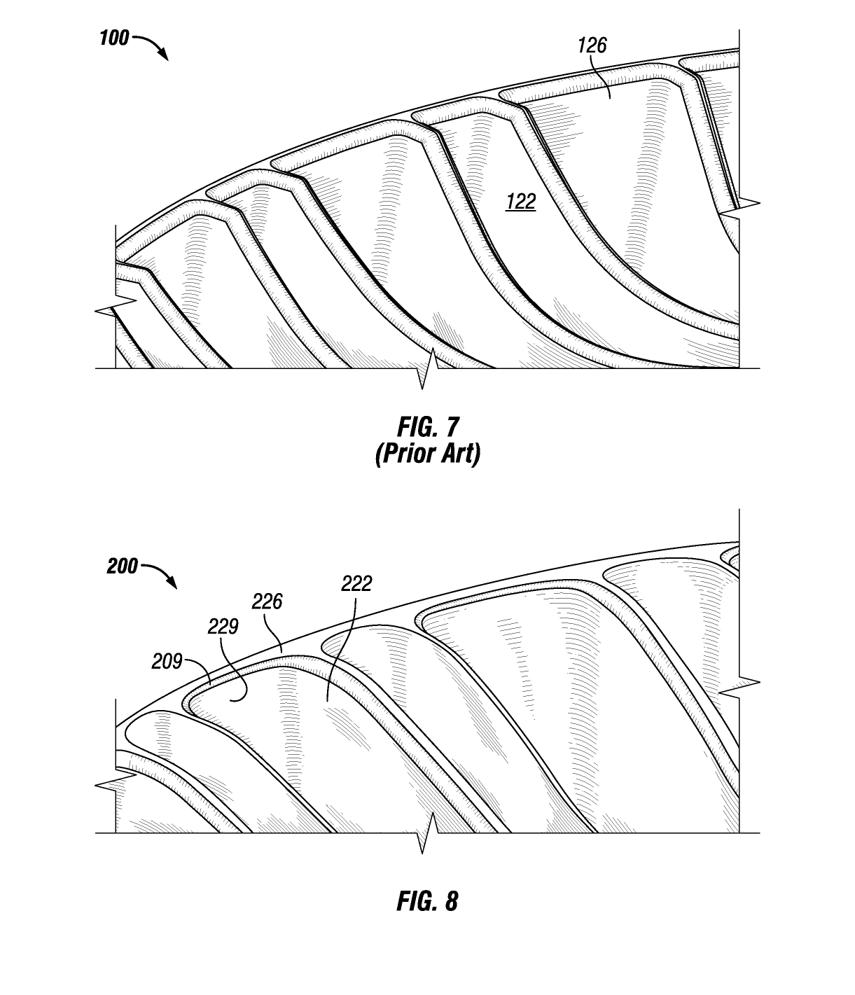

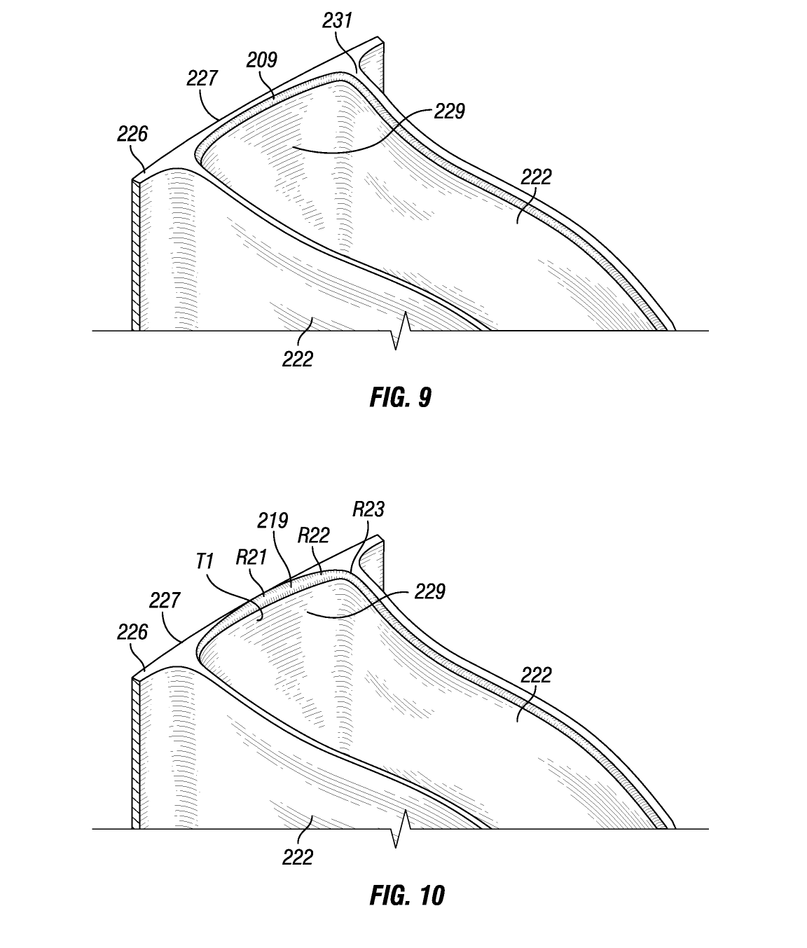

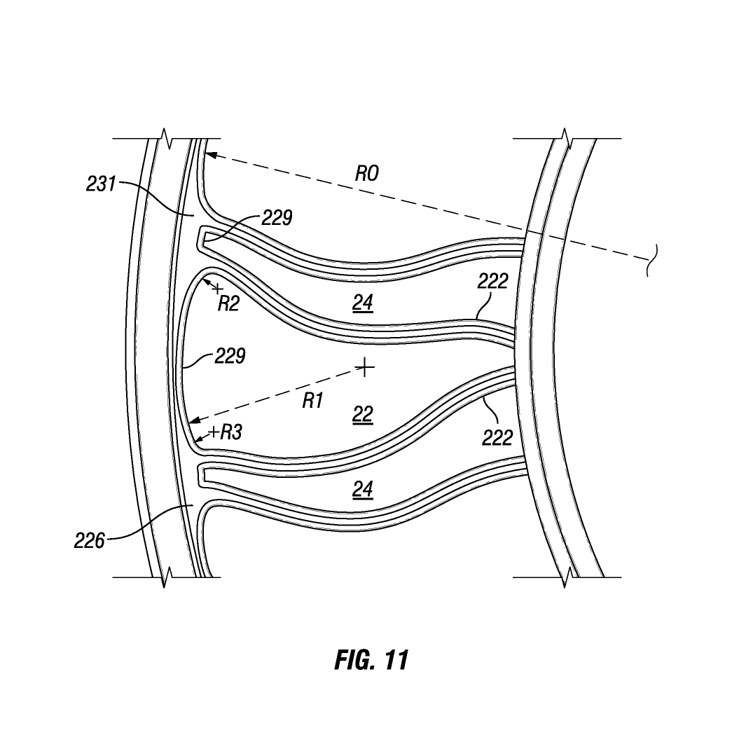

The problem of entrained air bubbles can be alleviated if this equilibrium is disrupted in a manner to drive the bubbles to a portion of the mold where venting can occur. One such geometry is shown for the non-pneumatic structure 200 in FIG. 8 and FIG. 9, and in the embodiment of FIG. 10, where the inner surface 229 of the outer interface band 226 possesses a surface having a reduced radius of curvature. Throughout the discussion, elements that are similar between the non-pneumatic structure 200 and the reference non-pneumatic deformable structure 100 will use correspondingly similar notation. The edge radius 209 of the non-pneumatic structure 200 may be constant between spokes as shown in FIG. 9 or may have a variable edge radius 219 along the edge of the cylindrical portion of the interface element and for the corresponding mold geometry as the embodiment shown in FIG. 10.

In the embodiment of FIG. 10, the edge radius has its maximum value R21 in the portion of the interface element that is situated circumferentially about mid way between each of the adjacent spokes. The edge radius continuously decreases circumferentially from the mid point of the interface element towards the intersection of the interface element with the spoke 222 to reach a minimum radius R23. The effectiveness of the edge radius alone diminishes, however, at equilibrium angles greater than 45 degrees. Such large equilibrium angles may occur, for example, as the rotational velocity a increases.

In the embodiments shown in FIGS. 8, 9, and 10 the outer interface element 226 varies in thickness, having a minimum value in the portion of the interface element that is situated circumferentially about midway between each of the adjacent spokes. The outer interface element thickness continuously increases circumferentially from the midpoint of the interface element towards the intersection of the interface element with the spoke 222 to reach a maximum thickness. Since the outer surface 227 of the outer interface element 226 possesses a longitudinally circular profile having a constant radius at a given distance axially from the outer surface of the outer interface element, the variation of the thickness of the outer interface element 226 corresponds to an increasing angle between the inner surface 229 of the outer interface element and the direction normal to the radial direction from the midpoint between each of the adjacent spokes and the intersection of the interface element 226 with the spoke 222.

Of the embodiments shown, the majority of the inner surface 229 of the outer interface element 226 is simply curved, meaning that it is curved in the longitudinal direction only. The inner surface may still possess radiuses edges at the intersection between the inner surface and the axial end surfaces of the outer interface element.

FIG. 11 depicts a simplified example geometry to control the angle that the radially inner surface 229 of the outer interface element 226 by defining a curvature of the inner surface 229 by a plurality of control radii, R1, R2 and R3. To aid in the removal of entrained air bubbles and drive the bubbles to a portion of the mold where venting can occur, the radii defining the curvature of the inner surface 229 possess values that are less than the maximum distance between the inner surface 229 and the axis of rotation of the tire. In the embodiment shown, the geometry describing the longitudinal curvature of the inner surface is comprised of three control radii, R1, R2 and R3. Radius R1 describes the curvature of a portion of the inner surface 229 adjacent to portions of the inner surface 229 that are described by radius R2 and R3, respectively, which also each adjoin one of the two adjacent web elements 222. An advantage of the inner surface of the outer interface element having a reduced radius of curvature is that it urges the air bubbles to a location where venting can occur. The vector angle urging the bubbles to vent continues to increase even more towards the longitudinal direction of the non-pneumatic structure 200 even when the equilibrium angle becomes greater than 45 degrees. The reduced radius of curvature of the inner surface 229 also presents a force to urge bubbles that may be stuck to the inner surface 229 of the outer interface element 226, and failed to migrate to the edge of the intersection of the inner surface 229 and the axial end surface of the outer interface element 226. For the exemplary embodiment of non-pneumatic structure 200, the bubbles can vent in the area near the second or third control radii, R2 or R3.

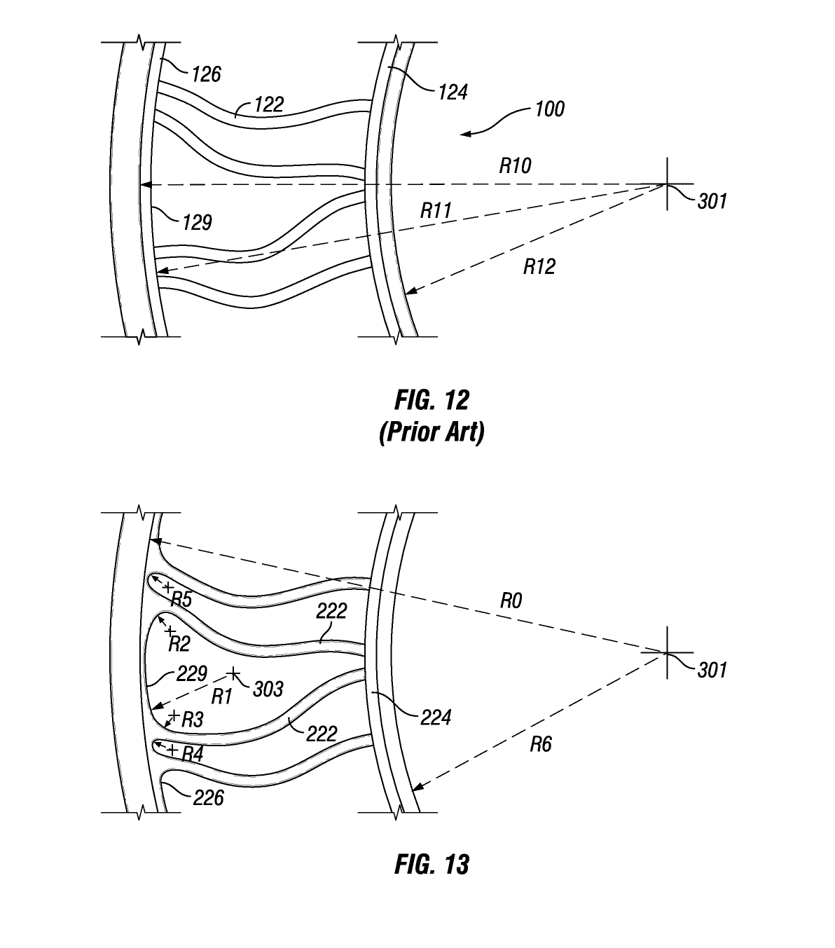

The function of the variable edge radius can be better appreciated by reference to FIG. 12 and FIG. 13, which provides and comparison of the reduced curvatures of the inner surface 229 of the outer interface element 226 shown in FIG. 13 with an inner surface having a radius of curvature equal to the distance between the inner surface and the axis of rotation, as shown in FIG. 12. For this illustrative example, a bubble can be thought to be at the tip of the arrow of R1. It can be seen that the buoyancy force vector FB will tend to drive the bubble “uphill” in a direction downward and parallel to the plane of FIG. 13. In this sense, the bubble is urged to move to a circumferential location towards the control radius R3, and then ultimately towards the spoke 222 and to inner interface element 224 where venting can occur. By comparison to the reference non-pneumatic deformable structure 100 shown in FIG. 12, the outer interface element 126 having an inner surface 129 with a radius of curvature equal to the distance between the inner surface and the axis of rotation 301 lacks the “uphill” profile of the outer interface element 226. Therefore, the buoyancy force FB will not act to move a bubble, similarly positioned, in the circumferential direction.

Stated in another way, the reduced radius of curvature of the inner surface 229 of the outer interface element 226 follows a curvature about at least one axis of rotation 303 located between the axis of rotation 301 of the non-pneumatic structure 200 and the inner surface 229. The reduced radius of curvature inner surface 229 may follow a curvature comprised of multiple portions, each following as radius of curvature about multiple axes of rotations, such as the three shown in FIG. 13 by R1, R2 and R3.

Returning to FIG. 11, one observes that the inner surface 229 of the outer interface element 226 has a reduced radius of curvature between every other pair of spokes. In the mold used to manufacture the non-pneumatic structure 200, the reduced radius of curvature of the inner surface 229 is applied to the first set of cores which project downward from the upper mold part to form a first set of voids 22 on the molded product. However, the second set of fingers projecting from the lower mold part, which form a second set of voids 24, mate with the upper mold part in a manner that allows venting to occur along the top edge of the outer interface element 226. Thus, a smaller radius of curvature, R5, of the inner surface 229 of the outer interface element, while present in the embodiment shown in FIGS. 8, 9, 10 and 13 is not essential. The embodiment, such as shown in FIG. 11, possesses an inner surface 229 at the outer interface element 226 that possesses a radius of curvature equal to the distance from the inner surface 229 and the axis of rotation. Since the mold provides venting at the intersection of the inner surface 229 and the surface 231 at the axial end of the outer interface band 226, a reduced radius of curvature of the inner surface 229 common to the second set of voids 24 is not necessary.

While this invention has been described with reference to particular embodiments and examples thereof, it shall be understood that such description is by way of illustration and not by way of limitation. Accordingly, the scope and content of the invention are to be defined only by the terms of the appended claims.

1. A non-pneumatic tire having an axis of rotation about a central axis, said tire comprising an outer interface element having a circumference and an axial width, an inner interface element having a circumference and an axial width, a plurality of web spokes positioned therebetween, and said web spokes being oriented in a generally radial direction, and the common surfaces of said inner interface element, said outer interface element, and a pair of adjacent web spokes forming a void space, wherein said surface of said outer interface element common to said void space possesses a longitudinal curvature having a radius of curvature in the longitudinal direction, whereas the maximum radius of curvature in the longitudinal direction at any given point along said surface of said outer interface element common to said void space is less than the distance between said point and said central axis of said tire.

2. The molded article according to claim 1, wherein said radius of curvature of said surface of said outer interface element has a value that is between ninety five percent of the maximum distance between the axis of rotation and said surface of said outer interface element and the maximum longitudinal distance between the opposing surfaces of said pair of adjacent web spokes.

3. A non-pneumatic tire having an axis of rotation about a central axis, said tire comprising an outer interface element having a circumference and an axial width, an inner interface element having a circumference and an axial width, a plurality of web spokes positioned therebetween, and said web spokes being oriented in a generally radial direction, and the common surfaces of said inner interface element, said outer interface element, and a pair of adjacent web spokes forming a void space, wherein said surface of said outer interface element common to said void space between said adjacent web spokes possesses a longitudinal curvature about at least one axes, each said at least one axes is positioned between said central axis and said surface of said outer interface element common to said void space and the each at least one axes is parallel to said central axis.

4. The non-pneumatic tire according to claim 3, wherein said at least one axis is comprised of a first axis, a second axis and a third axis.

5. The non-pneumatic tire according to claim 4, wherein said surface of said outer interface element common to said void space is comprised of a first curved portion with a radius of curvature extending about said first axis, a second curved portion with a radius of curvature extending about said second axis, and a third curved portion with a radius of curvature extending about said third axis, wherein said second curved portion is between and continuous with said first curved portion and said third curved portion.

7. A mold for a molded article comprising an upper mold part and a lower mold part capable of rotation about a central axis, said upper mold part further comprising a first set of cores projecting downward from the top of the mold and terminating axially in contact with said lower mold part to form a first set of voids in the molded article, said lower mold part comprising a second set axially oriented cores or fingers projecting upward from the bottom of the mold and terminating axially in contact with said upper mold part and terminating axially in contact with said upper mold part to form a second set of voids in the molded article, wherein a void space between said first set of cores and said second cores forms a radially oriented web spoke in the molded article, a radially outer portion of said mold forming an outer interface element in the molded article and a radially inner portion of said mold forming an inner interface element in the molded article, wherein said radially outer portion of said mold forming said outer interface element in the molded article possesses a curvature in a longitudinal direction having at least one radius of curvature about at least one axis, each of said at least one axis always positioned between said first axis and said surface of said outer interface element common to said void space.

8. The mold according to claim 7, wherein said at least one axis is comprised of a first axis, a second axis and a third axis.

9. The non-pneumatic tire according to claim 8, wherein said radially outer portion of said mold forming said surface of said outer interface element common to said void space is comprised of a first curved portion with a radius of curvature extending to said first axis, a second curved portion with a radius of curvature extending to said second axis, and a third curved portion with a radius of curvature extending to said third axis, wherein said second curved portion is between and continuous with said first curved portion and said third curved portion.

10. The non-pneumatic tire according to claim 8, wherein said surface of said outer interface element common to said void space is comprised of a first curved portion with a radius of curvature extending to said first axis, a second curved portion with a radius of curvature extending to said second axis, and a third curved portion with a radius of curvature extending to said third axis, wherein said second curved portion is adjacent to and continuous with said first curved portion and said third curved portion.
